(19) United States
(12) Patent Application Publication
(10) Pub. No.: US 2015/0019417 A1
(43) Pub. Date: Jan. 15, 2015

(54) UPDATING A DIGITAL WALLET FROM FINANCIAL ACCOUNT ISSUER

(71) Applicant: GOOGLE INC., Mountain View, CA (US)

(72) Inventors: Mark William Andrews, San Francisco, CA (US); William Dennis Kunz, Mountain View, CA (US); Steve Chen, Los Altos, CA (US); Reena Nadkarni, Cupertino, CA (US); Jonathan M. Newman, Mountain View, CA (US); Buckner Woodford Clay, IV, San Francisco, CA (US); Michael Schenker, San Jose, CA (US); Titia Tin Yee Wong, Oakland, CA (US); Stephen Tai-Chung Hu, Sunnyvale, CA (US)

(21) Appl. No.: 13/928,349

(22) Filed: Jun. 26, 2013

(51) Int. Cl. G06Q 20/36

(52) U.S. Cl. CPC G06Q 20/363
USPC 705/41

(57) ABSTRACT

A digital wallet provider system provides an interface specification to a financial account issuer. Using the interface specification, the financial account issuer system provides user financial account information directly to the digital wallet provider system without requiring the user to enter the user's financial account information. Once the digital wallet provider system receives the user's financial account information from the financial account issuer system, the digital wallet provider system verifies the identity of the user and the completeness of the financial account information received from the financial account issuer system. The digital wallet provider then updates the user's digital wallet account, on behalf of the user, to include the user's financial account.

### TECHNICAL FIELD

The present disclosure relates generally to updating a user's digital wallet account, and more particularly to methods and systems that enable a digital wallet provider to add a user's financial account to the user's digital wallet account based on financial account information received directly from the issuer of the financial account.

### BACKGROUND

The use of digital wallets to replace or augment traditional wallets is becoming more common. To create a digital wallet account, such as server-side digital wallet account, a user must open a digital wallet account with a digital wallet provider. For each financial account that the user wishes to add to the digital wallet account, the user must manually enter the financial account information into the digital wallet account. This typically involves the user inputting specific account information into fields on a user interface of the digital wallet account. For example, if a user wishes to add a particular credit card account to the digital wallet account, the user must typically input the name of the account issuer, the account number, the expiration date of the credit card, and any security code associated with the credit card. Similarly, to add a checking account to a digital wallet account, the user must manually input the name of the bank providing the account, the account number associated with the user, and the bank routing number associated with the user. Oftentimes, to gather such information needed to add the card or bank account to a digital wallet account, the user must retrieve a credit card or check for the financial account the user seeks to add to the digital wallet. The user must then accurately transfer the information from the credit card or check into the fields of the digital wallet interface. This process and burdensome and prone to errors.

### SUMMARY

In certain example aspects described herein, a computer-implemented method for updating a digital wallet account of a user is provided. An issuer computing system associated with a user financial account provides the account information to a digital wallet provider system. The issuer computing system provides the user financial account information in response to an input into the issuer computing system providing an instruction to the issuer computing system. The instruction directs the issuer computing system to communicate the user's financial account information from the issuer computing system to a computing device of the digital wallet provider system that maintains the digital wallet record of the user. The digital wallet provider system verifies the identity of the user, and, in certain aspects, also verifies the financial account information received from the issuer computing system. When the digital wallet provider system verifies the identity of the user, the digital wallet provider system updates the digital wallet account of the user to include the user's financial account information received from the issuer computing system. In certain other example aspects described herein, a system for updating a digital wallet account of a user to include the user's financial account is provided, as well a computer program product to update a user's digital wallet account to include the user's financial account.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for updating digital wallet accounts, in accordance with certain example embodiments.

FIG. 2 is a block flow diagram depicting a method for updating a user digital wallet account directly from a financial account issuer system, in accordance with certain example embodiments.

FIG. 3 is a block flow diagram depicting a method for receiving financial account information from a financial account issuer system, in accordance with certain example embodiments.

FIG. 4 is a block flow diagram depicting a method for verifying user identity and user financial account information to be added to a user digital wallet account, in accordance with certain example embodiments.

FIG. 5 is a block diagram depicting a computer machine and module, in accordance with certain example embodiments.

### DETAILED DESCRIPTION OF EXAMPLE EMBODIMENTS

### Overview

The example embodiments described herein provide methods and systems for updating a user's digital wallet account to include a financial account of the user. A digital wallet provider provides an interface specification to a financial account issuer. Using the interface specification, the financial account issuer can provide user financial account information directly to the digital wallet provider, and into a digital wallet account, without requiring the user to enter the user's financial account information. Once the digital wallet provider receives the user's financial account information from the issuer of the financial account, the digital wallet provider can, in certain example embodiments, confirm the identity of the user and verify the completeness of the financial account information received. The digital wallet provider can then update the user's digital wallet account to include the user's financial account.

More particularly, in certain example embodiments, the digital wallet provider provides an interface specification to a financial account issuer that allows, over a network, secure communication between the digital wallet provider and the financial account issuer. For example, the digital wallet provider can provide the financial account issuer with an application programming interface (“API”) that allows secure communication of confidential financial information about a user's financial account to the digital wallet provider. In certain example embodiments, the digital wallet provider also can use the application programming interface to provide communications from the digital wallet provider to the financial account issuer. For example, the digital wallet provider can, in certain embodiments, use the application programming interface to inform the financial account issuer that the financial information received is complete (or that certain information is missing).

In addition to providing an interface specification to a financial account issuer, the digital wallet provider also creates a digital wallet account for a user. For example, the digital wallet provider receives a user request to create a digital wallet account. The digital wallet provider then creates the account with the user's credentials, including, for example, the user's name, billing address, shipping address, and payment account information. The digital wallet provider also can create or associate with the user's digital wallet account a user login name and user password so that the user can access the digital wallet account. The user can access the digital wallet account, for example, by logging in to a website of the digital wallet provider. The user credentials, along with the user login name and user password, can be stored with the digital wallet provider.

Using the interface specification, in certain example embodiments, the digital wallet provider receives financial account information for a user that desires to add a financial account to the user's digital wallet. That is, a particular user establishes (or has established) a financial account with a financial account issuer. When the user accesses the user's financial account, such as through a website of the financial account issuer, the financial account issuer presents the user with an option to add the user's financial account to the user's digital wallet account. In certain example embodiments, the financial account issuer can present the option as a user control button, such as an “add your card now” button, on the website of the financial account issuer. In certain example embodiments, the option may appear as a pop-up window or notice suggesting that the user add the user's financial account to the user's digital wallet account.

When the user selects the option to add the user's financial account to the digital wallet account, the financial account receives the input from the user and communicates the user's financial account information to the digital wallet provider on behalf of the user. The digital wallet provider then receives the user's financial account information. The financial account information can include, for example, the name of the user, the user's financial account number, an expiration date for the account, and billing and shipping address information. In certain example embodiments, the financial account issuer also may communicate additional data to the digital wallet provider, such as artwork, logos, or other metadata associated with the financial account. After later adding the user's financial account to the user's digital wallet account as described below, the digital wallet provider can display the artwork or logo in the user's digital wallet along with the user's financial account.

Once the digital wallet provider receives a user's financial account information, the digital wallet provider can, in certain example embodiments, verify the identity of the user. For example, when the user selects the option to add the user's financial account to the user's digital wallet, the website of the financial account issuer can re-direct the user to the log-in page for the user's digital wallet. The user can then enter the user's digital wallet credentials, such as the user's login name and user password. The digital wallet provider can then verify that the user is in fact the holder of the digital wallet account to which the financial account information is to be added by comparing the user's login credentials against the stored user credentials. In other words, the digital wallet provider can verify the identity of the user by having the user login to the user's digital wallet account.

In certain example embodiments, the digital wallet provider can also verify the financial account information received from financial account issuer. For example, the digital wallet provider can confirm that all the information needed to add the user's financial account to the user's digital wallet account was received from the financial account issuer. That is, digital wallet provider can confirm that the financial account issuer successfully provided the user's name and financial account number. If the digital wallet provider determines that any needed information is missing, for example, the digital wallet provider can communicate an error message, via the application programming interface, to the financial account issuer indicating that the financial account information verification was not successful. Additionally or alternatively, the digital wallet provider can also notify the user that the effort to add the user's financial account to the user's digital wallet account was unsuccessful.

If the digital wallet provider verifies the account information received from the financial account issuer, the digital wallet provider updates the user's digital wallet account to include user's financial account. That is, the user's financial account appears in the user's digital wallet account and the user can use the financial account to complete financial transactions of the user. In certain example embodiments, the digital wallet provider confirms to the user that the user's digital wallet account has been updated to include user's financial account. For example, once the digital wallet provider successfully updates the user's digital wallet account to include user's financial account, the digital wallet provider may provide a notice to the user, such as through an email to the user, that the user's financial account was successfully added to the user's digital wallet account. Alternatively or additionally, the financial account issuer may notify the user that the user's digital wallet provider successfully added the user's financial account to the user's digital wallet.

Because the financial account issuer provides the user's financial account information directly to the user's digital wallet provider as described herein, the user is not responsible for entering the user's financial information into the digital wallet. This process, in turn, simplifies the process of adding a user's financial account to the user's digital wallet account, thus enhancing the user's experience with both the financial account issuer and the digital wallet provider. Simplifying the process of adding a user's financial account to the user's digital wallet account also reduces information entry errors associated with user input of financial information into the digital wallet account.

### Example System Architecture

Turning now to the drawings, in which like numerals indicate like (but not necessarily identical) elements throughout the figures, example embodiments are described in detail.

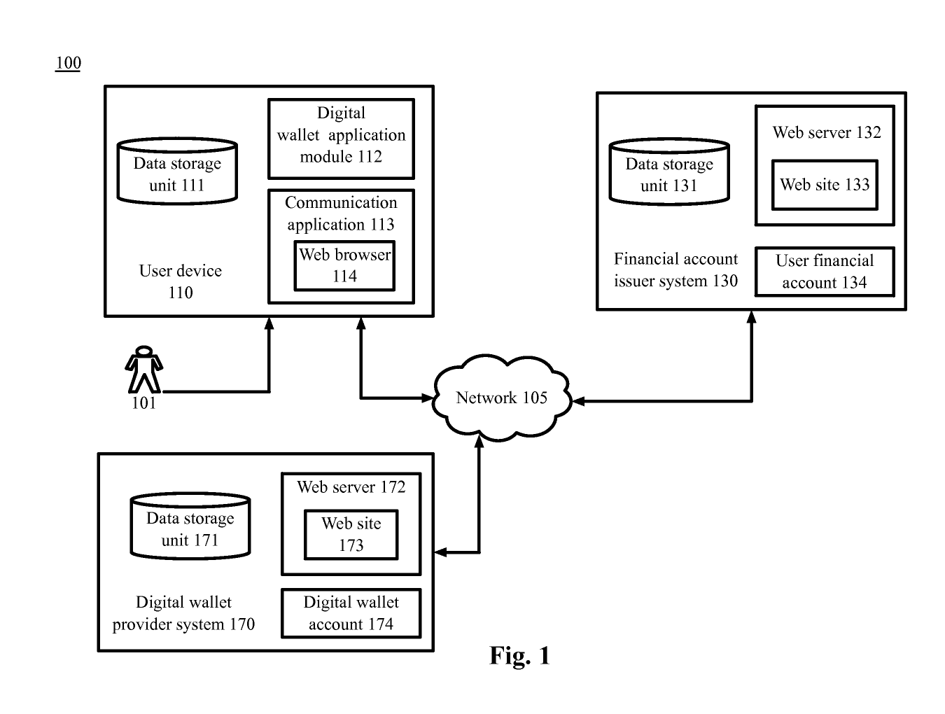

FIG. 1 is a block diagram depicting a digital wallet updating system, in accordance with certain example embodiments. As depicted in FIG. 1, the exemplary operating environment 100 includes a user network computing device 110, a digital wallet provider computing system 170, and a financial account issuer computing system 130 that are configured to communicate with one another via one or more networks 105. In some embodiments, a user associated with a device must install an application and/or make a feature selection to obtain the benefits of the techniques described herein.

Each network 105 includes a wired or wireless telecommunication means by which network devices (including devices 110, 170, and 130) can exchange data. For example, the network 105 can include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment.

Each network device 110, 170, and 130 includes a device having a communication module capable of transmitting and receiving data over the network 105. For example, each network device 110, 170, and 130 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 170, and 130 are operated by end-users or consumers, digital wallet provider operators, and financial account issuer operators, respectively.

The user 101 can use a communication application 113, such as a web browser application 114 or a stand-alone application, to view, download, upload, or otherwise access documents or web pages via a distributed network 105. The network 105 includes a wired or wireless telecommunication system or device by which network devices (including devices 110, 170, and 130) can exchange data. For example, the network 105 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer based environment. The communication application 113 can interact with web servers or other computing devices connected to the network 105, including the user network device 110, the web server 172 of the digital wallet provider system 170, and the financial account server 132 of the financial account issuer.

The user device 110 can include a digital wallet application module 112 that is configured to interact and communicate with the digital wallet provider system 170 via the communication application 113. For example, the digital wallet application module 112 can interact with the communication application 113, which in turn can be used and configured to communicate and share data with the digital wallet provider system 170 via the network 105. The digital wallet application module 112 can also be used and configured to communicate and share data with the financial account issuer system 130. For example, the digital wallet application module 112 can interact with the communication application 113, which in turn can be used and configured to communicate and share data with the financial account issuer system 130 via the network 105.

The digital wallet application module 112 can encompass any application, hardware, software, or process the user device 110 can employ to assist the user 101 in completing a purchase. The digital wallet application module 112 can interact with a communication application 113 as described herein or can be embodied as a companion application of the communication application 113. As a companion application, the digital wallet application module 112 executes within the communication application 113. That is, a digital wallet application module 111 can be an application program embedded in the communication application 113. The user 101 can use the user device 110 to register the digital wallet application module 112, or the digital wallet account 174 and/or access the digital wallet account 174 account of the user 101 with the digital wallet provider system 170. The user device 110 can comprise appropriate technology that includes or is coupled to a web server (for example, a web browser application, or other suitable application for interacting with web page files).

The user 101 can interact with a user interface provided by the digital wallet application module 112 to add, modify, or remove financial account information from a digital wallet account 174. In a web browser companion application embodiment, this user interface can be provided via the web browser 114. Additionally or alternatively, the financial account information may be synchronized with a remote storage location, such as a cloud-computing environment (not shown). That is, the user 101 can access the financial account information stored at the remote location using another device, such as a desktop computer connected to the network 105. The remote storage location can update the digital wallet account 174 in response to any changes made at the remote storage location.

Using the digital wallet application module 112, the user 101 can request a purchase from a merchant system (not pictured), for example. In an example embodiment, the purchase can be initiated by a wireless “tap” of the mobile device 110 with a point-of-sale (POS) terminal. In an alternative example embodiment, the purchase is initiated when the user 101 enters an account identification number at the POS terminal or in the user device 110. In another example embodiment, the purchase is initiated online with a merchant server (not shown). The purchase may be initiated via the merchant website, for example. In yet another example embodiment, the purchase is initiated by use of a permanent/temporary virtual/physical token, QR code, bar code, or other suitable machine-readable medium captured by the terminal reader. The merchant's POS terminal can, for example, interact with the financial account issuer system 130 to process a payment.

The user device 110 also comprises a data storage unit 111 that is accessible by the digital wallet application module 112, the communication application 113, and the web browser 114. The exemplary data storage unit 111 can include one or more tangible computer-readable storage devices. The data storage unit 111 can be stored on the user device 110 or can be logically coupled to the user device 110. For example, the data storage unit 111 can include on-board flash memory and/or one or more removable memory cards or removable flash memory.

The digital wallet provider system 170 maintains the digital wallet record of the user 101 and comprises a web server 172, a web site 173, and a digital wallet account 174. The web server 172 can represent the computer-implemented system that the digital wallet provider system 170 employs to host the website 173 of the digital wallet provider system 170. The web server 172 and associated website 173 of the digital wallet provider system 170 can represent the computer-implemented system that the digital wallet provider system 170 uses to provide and maintain a digital wallet account 174 for a user 101, for example. In certain example embodiments, digital wallet provider system 170 can execute and operate within the digital wallet application module 112 of the user device 110, or it can execute and operate as a companion application to the digital wallet application module 112 of the user device 110. Alternatively, the digital wallet provider system 170 can execute and operate independently of the digital wallet application module 112 of the user device 110. In such embodiments, the digital wallet provider system 170 is configured, for example, to communicate with the user device 110 via the network 105. The digital wallet provider system 170 also comprises an accessible data storage unit 171, which can include an on-board flash memory and/or one or more removable memory cards or removable flash memory.

The digital wallet provider system 170 is configured to receive and store content from a financial account issuer system 130 and to communicate with the financial account issuer system 130 via the network 105. For example, the digital wallet provider system 170 can receive financial account information for a user 101 directly from the financial account issuer system 130. The financial account information for each financial account can be maintained by the digital wallet provider system 170 and stored in the data storage unit 171 of the digital wallet provider system 170. The digital wallet provider system 170 thus enables the storage of one or more financial accounts (and associated financial account information) that can be used for online purchases and/or offline purchases of the user 101.

The financial account issuer system 130 comprises a financial account server 132, which can represent the computer-implemented system that the financial account issuer system 130 employs to host a web site 133 of the financial account issuer system 130. The financial account web server 132 and associated website 133 of the financial account issuer system 130 can represent the computer-implemented system that the financial account issuer system 130 uses to create, provide, maintain a user financial account 134 for a user 101. The financial account issuer system 130 also comprises a data storage unit 131, which can used to store financial account information associated with a user financial account 134.

The financial account issuer system 130 is configured to receive and store financial account information from a user 101 to create a user financial account 134. For example, financial account information from a user 101 can be received via the network 105 and stored in the data storage unit 131 of the financial account issuer system 130. The financial account issuer system 130 is also configured to communicate with digital wallet provider system 170 via the network 105. For example, the financial account issuer system 130 can provide financial account information of a user 101 directly to the digital wallet provider system 170 via the network 105.

It will be appreciated that the network connections shown are exemplary and other means of establishing a communications link between the computers and devices can be used. Moreover, those having ordinary skill in the art having the benefit of the present disclosure will appreciate that the user device 110, the digital wallet provider system 170, and the financial account issuer system 130 illustrated in FIG. 1 can have any of several other suitable computer system configurations. For example, a user device 110 can be embodied as a mobile phone or handheld computer may or may not include all the components described above.

### Example Processes

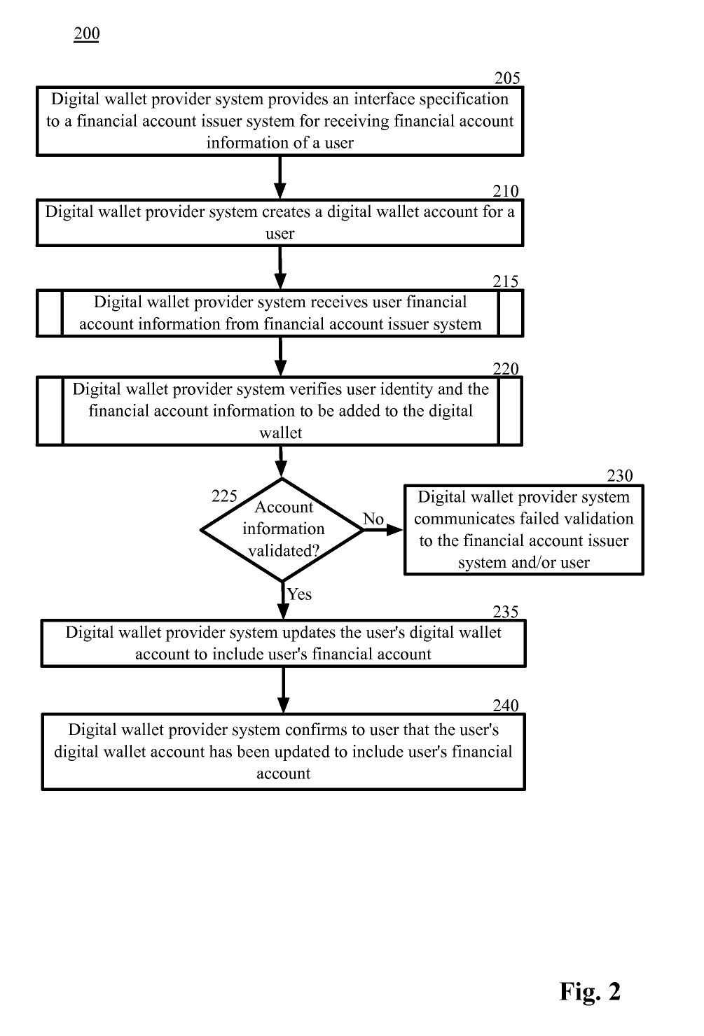

The example methods illustrated in FIG. 2 are described hereinafter with respect to the components of the example operating environment 100. The example methods of FIG. 2 may also be performed with other systems and in other environments.

FIG. 2 is a block diagram depicting a method for updating a user digital wallet account directly from a financial account issuer system, in accordance with certain example embodiments.

With reference to FIG. 2, in block 205, the digital wallet provider system 170 provides an interface specification to a financial account issuer system 130 that allows the digital wallet provider system 170 to receive user financial account information from the financial account issuer system 130. That is, the digital wallet provider system 170 communicates an interface specification to the financial account issuer system 130 that allows the financial account issuer system 130 to provide financial account information to the digital wallet provider system 170. Using the interface specification, for example, the computing system of the financial account issuer system 130 can seamlessly transfer specific financial information for a user financial account 134 to the computing system of the digital wallet provider system 170. The transfer, for example, can occur directly via the network 105.

The interface specification can be designed to enable receipt of any type of financial account information typically associated with a user financial account 134. For example, the financial account information can comprise a financial payment account, such as a credit card account, a debit card account, a checking account, a savings account, a loyalty rewards account, or any other type of account that can be used to make a purchase. The financial account information can also include a financial account identifier (for example, account number, card number, and/or secure identification number) and an expiration date of one or more payment accounts associated with the financial account. The financial account information can also comprise credentials of the user 101 associated with the account, such as such as name, contact information (for example, residential address, phone number, e-mail address), demographic information, or any other suitable information associated with the user 101. The financial account information can also comprise a user billing address for the account, as well as shipping information, such as one or more shipping addresses, preferred shipping provider(s), and preferred shipping method(s) (for example, ground, air, expedited, signature confirmation, or other shipping method).

In certain example embodiments, the interface specification also allows the computing system of the digital wallet provider system 170 to return error messages to the financial account issuer system 130, such as verification or validation errors associated with the address, name, account number, expiration date, and phone number of the user 101. The interface specification can also allow the digital wallet provider system 170 to inform or notify the computing system of the financial account issuer system 130 of attempted duplicate entries, such as the attempted entry of a financial account that has already been added to the digital wallet account 174 of the user 101. In still additional example embodiments, the interface specification allows the computing system of the financial account issuer system 130 to update the status of a user financial account 134 that has been added to the digital wallet account 174 of a user 101. For example, the computing system of the financial account issuer system 130 can, using the interface specification, update the expiration date of a financial account such that the account expires at a later date.

In certain example embodiments, the interface specification is configured to receive and communicate certain metadata regarding financial account issuer system 130. For example, the interface specification can be configured to allow the digital wallet provider system 170 to receive artwork, logos, marks, designs, emblems, symbols, labels, or any other such metadata associated with the financial account issuer system 130. After later adding a user financial account 134 to the digital wallet account 174 of the user 101 as described below, the digital wallet provider system 170 can display the artwork, logo, etc. in the digital wallet account 174 of the user 101 along with the added user financial account 134.

In certain example embodiments, the interface specification comprises a customized application programming interface. For example, the application programming interface facilitates interactions between the digital wallet provider system 170 and the financial account issuer system 130. The application programming interface can, for example, provide rules, commands, and standards that allow the financial account issuer system 130 system to transfer specific financial account information for a user financial account 134 to a digital wallet provider system 170. In certain example embodiments, the digital wallet provider system 170 can also use the application programming interface to provide information from the computing system of the digital wallet provider system 170 to the computing system of the financial account issuer system 130. For example, the digital wallet provider system 170 can use the application programming interface to inform the financial account issuer system 130 that the financial account information received is complete (or that certain information is missing and/or that verification errors exist).

In block 210, the digital wallet provider system 170 creates a digital wallet account 134 for a user 101. For example, a user device 110 communicates a request to the digital wallet provider system 170 to create the digital wallet account 174 via the network 105. The digital wallet provider system 140 receives the request of the user 101 via the network, and creates a digital wallet account 174 for the user using the user's personal credentials.

The credentials of the user 101 can include, for example, the user's name, billing address, shipping address, or any other user information typically associated with the user 101 of a digital wallet account 174. For example, the digital wallet provider system 170 can also create (or associate with the user's digital wallet account 174) a user login name and user password so that the user 101 can access the digital wallet account 174 of the user 101. The user 101 can then access the digital wallet account 174, for example, by logging in to a website 173 of the digital wallet provider system 170 and providing the login credentials.

The user 101 credentials, including with the user login name and user password, can be recorded or stored with the digital wallet provider system 170, such as in the data storage unit 171 of the digital wallet provider system 170. In certain example embodiments, the digital wallet provider system 170 can also associate the user's credentials, login, and password information with the digital wallet application module 112 and, for example, store the credentials on the data storage unit 111 of the user device 110. In accordance with the embodiments described herein, the digital wallet provider system 170 maintains the digital wallet record of the user 101.

When establishing a digital wallet account 174, the user 101 can also provide financial account information for accounts that the user 101 desires to add to the accounts. For example, based on information received from the user 101, the user 101 may seek to add multiple debit/credit cards maintained by multiple issuers (including the proxy card system operating as an issuer), stored value cards (for example, gift cards, prepaid cards, re-loadable transaction cards, exchange cards, and other forms of non-credit based value cards), loyalty cards or store rewards cards, value added service accounts (for example, coupons, vouchers for prepaid offers, redemption offers, and other forms of offers), peer-to-peer transaction accounts, bank accounts, and/or other forms of financial accounts.

In certain example embodiments, the user 101 may establishes rules with the digital wallet provider system 170 for selecting a financial account for payment in a transaction. For example, the user 101 may use a proxy card application, a website 173 on the web server 172 of the digital wallet provider system 170, or any suitable hardware or software applications to establish rules. In certain example embodiments, the user 101 can select from a selection of rules that the digital wallet provider system 170 supplies. Alternatively or additionally, the user 101 can input new rules when establishing the digital wallet account 174 with the digital wallet provider system 170.

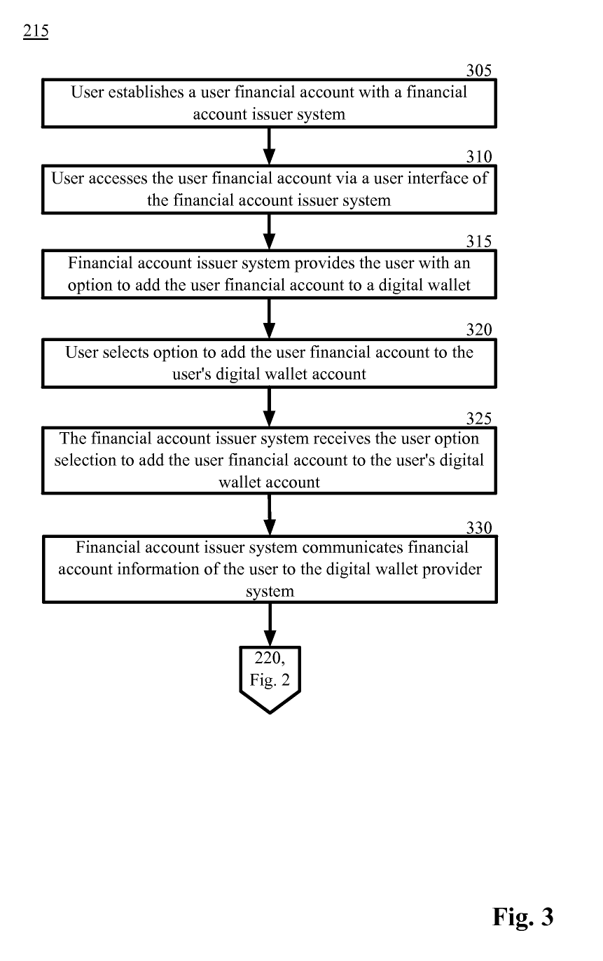

In block 215, the digital wallet provider system 170 receives financial account information from the financial account issuer system 130. For example, once a user 101 establishes a financial account 134 with the financial account issuer system 130, the user can access the financial account 134 such as through a user interface on the website 133 of the financial account issuer system 130. That is, a user 101 can enter user financial account 134 login credentials into a user interface of the financial account issuer system 130, such as a user name and password, thereby accessing the financial account 134. While the user 101 is logged in to the user financial account 134, for example, the financial account issuer system 130 can provide an option for the user 101 to add the user financial account 134 to the digital wallet account 174 of the user. Once the user 101 selects the option to add the user financial account 134 to the digital wallet account 174 of the user 101, the computing system of the financial account issuer system 130 receives the input selection from the user 101. The financial account issuer system 130 then communicates the specific financial account information of the user 101 to the digital wallet provider system 170 via the network 105. That is, the user's selection of the option operates as an instruction for the financial account issuer system 130 to transfer the financial account information of the user 101 to the digital wallet provider system 170. The computing system of the digital wallet provider system 170 then receives the financial account information of the user 101 via the network 105. The details of block 215 are described in further detail below with reference to FIG. 3.

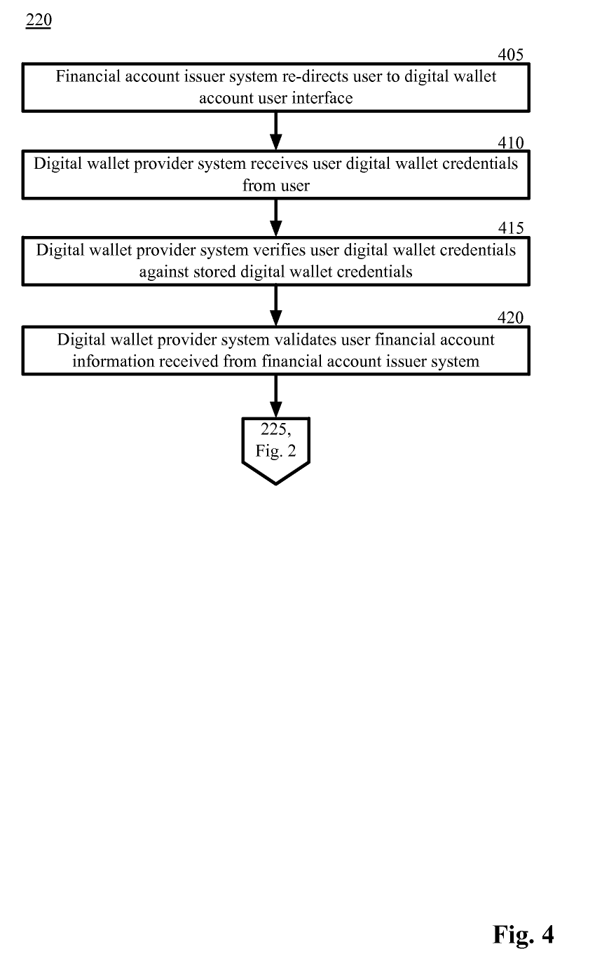

In block 220, the digital wallet provider system 170 verifies the identity of the user 101. The digital wallet provider system 170 also verifies the account information that the digital wallet provider system 170 receives from the financial account issuer system 130. For example, when the user 101 selects the option to add the user financial account 134 and the financial account issuer system 130 receives the input of the user 101, the financial account issuer system 130 can, in certain example embodiments, re-direct the user 101 to an interface for the digital wallet account 174 of the user 101. There, the user 101 can log in to the digital wallet account 174 of the user 101, thereby providing verifying credentials such as the login name and password associated with the digital wallet account 174 of the user 101. The digital wallet provider system 170 can then verify the identity of the user 101 by matching the entered login name and password of the user 101 with the stored record of user credential information. Additionally or alternatively, the financial account issuer system 130 can provide the user log-in credentials to the digital wallet provider system 170, and the digital wallet provider system 170 verifies the identify of the user 101 by verifying the user log-in credentials received from the financial account issuer system 130. Once the digital wallet provider system 170 verifies the identity of the user 101, the digital wallet provider system 170 can also validate (verify) the financial account information that it has received from the financial account issuer system 130. That is, the digital wallet provider system 170 can confirm that the financial account information received from the financial account issuer system 130 is complete. The details of block 220 are described in further detail below with reference to FIG. 4.

If in block 220 the digital wallet provider system 170 is unable to successfully verify the user financial account information received from the financial account issuer system 130, the method follows the “NO” branch block 225 to block 230 of FIG. 2. If in block 220 the digital wallet provider system 170 verifies the user's financial account information received from the financial account issuer system 130, the method follows the “YES” branch of block 225 to block 235 of FIG. 2.

In block 230, the digital wallet provider system 170 can, in certain example embodiments, communicate an unsuccessful verification of the received financial account information to the financial account issuer system 130. That is, if the digital wallet provider system 170 determines that the received financial account information for a user financial account 134 is incomplete or inaccurate, for example, the digital wallet provider system 170 can notify the financial account issuer system 130, via the network 105, that the received financial account information did not pass the verification process. In certain example embodiments, the digital wallet provider system 170 can return specific validation or verification errors to the financial account issuer system 130 using the interface specification described herein. For example, the validation errors may comprise errors associated with the address, name, account number, expiration date, and phone number of the user 101. In certain example embodiments, the digital wallet provider system 170 can notify the financial account issuer system 130 of attempted duplicate entries, such as the attempted entry of a financial account that has already been added to the digital wallet account 174 of the user 101.

In block 235, the digital wallet provider system 170 updates the digital wallet account 174 of the user 101 to include the financial account 134 of the user 101. That is, the digital wallet provider system 170 adds the financial account 134 of the user 101 to the digital wallet account 174 of the user 101 so that the user can utilize the financial account 134 to complete financial transactions of the user 101. For example, when a user 101 accesses the user's digital wallet account 134, such as by logging in to the digital wallet account 134 or by accessing the digital wallet application module 112 on the user device 110, the user can identify the financial account 134 as a payment option. The user can then utilize the added financial account 134 to conduct transactions with the digital wallet account 174 of the user 101. In certain example embodiments, digital wallet provider system 170 also updates the digital wallet account 174 of the user 101 to include artwork, logos, marks, designs, emblems, symbols, labels, or any other such metadata associated with the financial account issuer system 130. For example, such artwork, logos, marks, designs, emblems, symbols, labels may be displayed along with the financial account 134 that is added to the digital wallet account 174 of the user 101.

In block 240, in certain example embodiments, the digital wallet provider system 170 confirms to the user 101 that the user's digital wallet account 174 has been updated to include the financial account 134 of the user 101. That is, once the digital wallet provider system 170 successfully updates the digital wallet account 174 of the user 101 to include the user financial account 134, the digital wallet provider system 174 can provide a notice to the user 101 that the user financial account 134 was successfully added to the user's digital wallet account 174. For example, the digital wallet provider system 170 can provide an email message, text message, or any other type of message or alert to the user 101 via the network 105, thereby notifying the user 101 that the user financial account 134 was added to the digital wallet account 174 of the user 101. Alternatively or additionally, the financial account issuer system 130 may notify the user 101 that the digital wallet provider system 170 successfully added the user financial account 134 to the user's digital wallet account 174.

Although a user 101 may choose to add the financial account 134 of the user 101 to the digital wallet account 174 of the user 101 as described herein, the user 101 may, at the option of the user 101, remove the financial account 134 from the digital wallet account 174 at any time. For example, after adding the financial account 134 to the digital wallet account 174, the user 101 may login to the digital wallet account 174 via the web site 173 of the digital wallet provider system 170. There, the user 101 can select an option to remove the financial account 134 from the digital wallet account 174, thereby revoking all permissions associated with the digital wallet provider system's use of the financial account 134. For example, the user 101 can modify user profile settings associated with digital wallet account 174 to remove the financial account 134 from the digital wallet account 174 of the user 101. Additionally or alternatively, the financial account issuer system 130 may provide the user 101 with an option to remove the financial account 134 from the digital wallet account 174. If the user selects the option, for example, the financial account issuer system 130 communicates a revocation request to the digital wallet provider system 170. In response to the revocation request, the digital wallet provider system 170 removes the financial account 134 from the digital wallet account 174 of the user.

FIG. 3 is a block flow diagram depicting a method for receiving financial account information from a financial account issuer system, in accordance with certain example embodiments.

With reference to FIGS. 1 and 2, in block 305 of method 215, the user 101 establishes a user financial account 134 with the financial account issuer system 130. That is, before the user 101 can have a user financial account 134 added to the digital wallet account 174 of the user, the user 101 provides information to the financial account issuer system 130 to establish a user financial account 134. For example, the user 101 communicates information needed to open an account to the financial account issuer system 130, such as through the web site 133 of the financial account issuer system 130. The financial account issuer system 130 can then assign the user 101 a financial account 134, which typically includes associating a financial account number such as a bank account number or a credit card number with the user 101. To establish the user financial account 134, the user 101 must typically provide the user's name, birthday, valid identification (such as a social security number, driver's license number, or other government-issued identification), billing address, and/or shipping address. And to access the user financial account 134 online, the financial account issuer system 130 and the user 101 can establish user login credentials for the user financial account 134, such as a user name and password, thereby permitting user access to the user financial account 134. In certain example embodiments, the user 101 may be asked to provide answers to security questions associated with accessing the account.

In block 310, once the user 101 establishes a user financial account 134 with the financial account issuer system 130, the user 101 accesses the user financial account 134 via a user interface financial account issuer system 130. For example, the user 101 logs in to the web site 133 of the financial account issuer system 130, and the web site 133 provides a user interface to the user 101 so that the user 101 can enter information to access the user financial account 134 from the web site 133 of the financial account issuer system 130. Additionally or alternatively, the user interface may appear on the user device 110, such as through an application that the financial account issuer system 130 can provide to the user 101. With the user interface, the user 101 can, for example, input the user name and password associated with the user financial account 134. In certain example embodiments, the financial account issuer system 130 may also require the user 101 to re-enter answers to security questions associated with the user financial account 134. By inputting the login information into the user interface associated financial account issuer system 130, the user 101 can access the user financial account 134.

In block 315, the financial account issuer system 130 provides the user 101 with an option to add the user financial account 134 to the digital wallet account 174 of the user 101. That is, once a user 101 accesses the user financial account 134 as described herein, the financial account issuer system 130 presents an option (an opportunity) on the user interface for the user 101 to have user's digital wallet account 134 updated to include the user financial account 134. For example, the financial account issuer system 130 may present the option as a selectable user control button, such as an “add your card now” button, on the website 133 of the financial account issuer system 130.

In certain example embodiments, the financial account issuer system 130 can associate additional information with the option, such as instructions and/or details about adding the user financial account 134 to the digital wallet account 174 of the user 101. For example, the financial account issuer system 130 can also provide information informing the user 101 that selecting the option will permit the financial account issuer system 130 to add the user financial account 134 to the digital wallet account 174 of the user 101 on behalf of the user 101. The financial account issuer system 130 can also, for example, provide selectable control buttons regarding the “add your card now” option, such as “what is it?,” “why use it?,” “where can I shop?,” or other informational buttons that, when activated or accessed, provide further information regarding the “add your card now” option.

Additionally or alternatively, the financial account issuer system 130 may provide a link on the website 133 of the financial account issuer system 130, for example, that provides the option for the user 101 to have user's digital wallet account 134 updated to include the user financial account 134. Additionally or alternatively, the financial account issuer system 130 may provide the option as a pop-up window associated with the user login to the user financial account 134. The pop-up window can include, for example, information associated with the digital wallet provider system 170, such as artwork, logos, marks, designs, emblems, symbols, and/or labels indicating the origin of the digital wallet provider system 170 to which the digital wallet account 174 of the user 101 belongs. In certain example embodiments, the option can be presented on the user interface on the user device 110, such as through an application that the financial account issuer system 130 can provide to the user 101.

In block 320, the user 101 selects the option to add the user financial account 134 to the digital wallet account 174 of the user 101. For example, if the financial account issuer system 130 provides the option as a selectable control button, the user 101 clicks on (or otherwise activates) the control button. That is, the user 101 can click an “add your card now” button that the financial account issuer system 130 provides on the user interface for the user financial account 134. In other example embodiments, the user 101 can click on (or otherwise access) a pop-up window or link providing the option. By selecting the option, the user 101 indicates a desire to have the user financial account 134 added to the digital wallet account 174 of the user 101 on behalf of the user 101. That is, the user's selection of the option operates as an instruction from the user 101 for the financial account issuer system 130 to provide the financial account information of the user 101 to the digital wallet provider system 170 as described herein.

In block 325, the financial account issuer system 130 receives the option selection of the user 101 to add the user financial account 134 to the digital wallet account 134 of the user 101. For example, once the user 101 selects the option, the selection is communicated to the financial account issuer system 130 via the network 105. The financial account issuer system 130 then receives the option selection of the user 101, the selection operating as an instruction for the financial account issuer system 130 to communicate the financial account information of the user 101 to the digital wallet provider system 170. That is, the financial account issuer system 130 receives an input to communicate the user's financial account information 134 to the digital wallet provider system 170.

In certain example embodiments, once the financial account issuer system 130 receives the selection of the user 101 to add the user financial account 134 to the digital wallet account 134 of the user 101, the financial account issuer system 130 may provide the user 101 with a confirmation control button, such as a “confirm” button, so that that the user 101 can confirm the intention of the user 101 to have the user financial account 134 added to the digital wallet account 134 of the user 101. If the user 101 confirms the intention of the user 101 to have the user financial account 134 added to the digital wallet account 134 of the user 101, the method proceeds to block 330 described below. If the user fails to confirm the intention of the user 101 to have the user financial account 134 added to the digital wallet account 134 of the user 101, the method will cease.

In block 330, once the financial account issuer system 130 receives the instruction of the user 101 to add the user financial account 134 to the digital wallet account 134 of the user 101, the financial account issuer system 130 communicates the financial account information of the user 101 to the digital wallet provider system 170. That is, using the interface specification described herein, the computing system of the financial account issuer system 130 seamlessly transfers financial account information about the user financial account 134 of the particular user 101 to the computing system of the digital wallet provider system 170 via the network 105. In certain example embodiments, the financial account issuer system 130 also communicates the user login credentials of the user financial account 134 to the digital wallet provider system 170. The digital wallet provider system 170 can then, in certain example embodiments, verify the identity of the user 101 based on the user login credentials of the user financial account 134 (in addition or alternatively to verifying the user digital wallet login credentials as described herein).

In certain example embodiments, an application programming interface facilitates the interactions between the digital wallet provider system 170 and the financial account issuer system 130 such that financial account information can be transferred from the financial account issuer system 130 to the digital wallet provider system 170 via the network 105. That is, when the computing system of the financial account issuer system 130 receives an input to add a user financial account 134 to a user digital wallet account 174, the application programming interface can facilitate the transfer of financial account information about the user financial account 134 to the digital wallet provider system 170 on behalf of the user 101. In certain example embodiments, the financial account issuer system 130 can also communicate to the digital wallet provider system 170, via the network 105, artwork, logos, marks, designs, emblems, symbols, or labels associated with the financial account issuer system 130. The digital wallet provider system 170 then receives the communicated financial account information and, in certain example embodiments, the digital wallet provider system receives artwork, logos, marks, designs, emblems, symbols, or labels associated with the financial account issuer system 130. The method then follows to block 220 of FIG. 2.

FIG. 4 is a block flow diagram depicting a method for verifying user identity and user financial account information to be added to a user digital wallet account, in accordance with certain example embodiments.

With reference to FIGS. 1 and 2, in block 405 of method 220, the financial account issuer system 130 re-directs the user 101 to the digital wallet account 174 user interface. That is, once the user 101 selects the option to add user financial account 134 to the digital wallet account 174 of the user 101, such as by clicking on a user control button, the financial account issuer system 130 directs the user 101 away from the user interface of the financial account issuer system 130 and a user interface associated with the digital wallet account 174 of the user 101. For example, when the user 101 clicks the user control button, the financial account issuer system 130 directs the user 101 to a user interface on the website 173 of the digital wallet provider system 170. There, the user 101 can enter the digital wallet credentials of the user 101 into the user interface associated with the web site 173 of the digital wallet provider system 170.

In certain example embodiments, a user 101 may select the option to have the user financial account 134 added to a digital wallet account, even though the user 101 has not yet established a digital wallet account. In such embodiments, the financial account issuer system 130 or the digital wallet provider system 170 can, for example, direct the user 101 to a user interface for establishing a user digital wallet account. For example, the web site 133 of the financial account issuer system 130 can direct the user 101 to a user interface of the website 173 of the digital wallet account system 170 where the user 101 can provide information to the digital wallet provider system 170 necessary to establish a digital wallet account 174 for the user 101. The user 101 can then establish a digital wallet account 174 with the digital wallet provider system 170. Once the digital wallet provider system 170 creates the digital wallet account 174 for the user 101, the method can proceed to block 410.

In block 410, the digital wallet provider system 170 receives the digital wallet account 174 credentials from the user 101. For example, after the user 101 is re-directed to the user interface associated with the digital wallet account 174 of the user 101, the user enters the user's digital wallet credentials, such as a user name and password associated with the digital wallet account 174 of the user 101. The digital wallet provider system 170 then receives the user credentials via the network 105. In certain example embodiments, when the user 101 selects the option to have the user financial account 134 added to a digital wallet account 134, the user may already be logged in to the digital wallet account 134. In such embodiments, the digital wallet provider system 170, for example, may have already received the credentials of the user 101 when the user 101 previously logged in to the digital wallet account 134 of the user 101.

In block 415, the digital wallet provider system 170 verifies the digital wallet credentials of the user 101 against stored digital wallet credentials. That is, after the digital wallet provider system 170 receives the digital wallet account 174 credentials from the user 101, the digital wallet provider system 170 confirms that the user's entered credentials match those on record for the digital wallet account 174 of the user 101. For example, the digital wallet provider system 170 can confirm that the user name and password that the digital wallet provider system 170 receives from the user 101 match the user name and password associated with the user 101 and the digital wallet account of the user 101. In certain example embodiments, the digital wallet provider system 170 may require the user 101 to provide additional verification information, such as answers to security questions that the user 101 has previously provided. Additionally or alternatively, the digital wallet provider system 170 verifies the identity of the user 101 based on the user login credentials of the user financial account 134 received from the financial account issuer system 130.

In block 420, the digital wallet provider system 170 verifies the financial account information received from the financial account issuer system 130. That is, the digital wallet provider system 170 confirms that it has successfully received, from the financial account issuer system 130, all of the financial account information necessary to update the digital wallet account 174 of the user 101 to include the user financial account 134. For example, the digital wallet provider system 170 can confirm that it has received the user's name, account number, financial account expiration date, and any security code associated with the user financial account 134. The digital wallet provider system 170 can also confirm, for example, that the use financial account 134 has not already been added to the digital wallet account 134 of the user 101.

### Other Example Embodiments

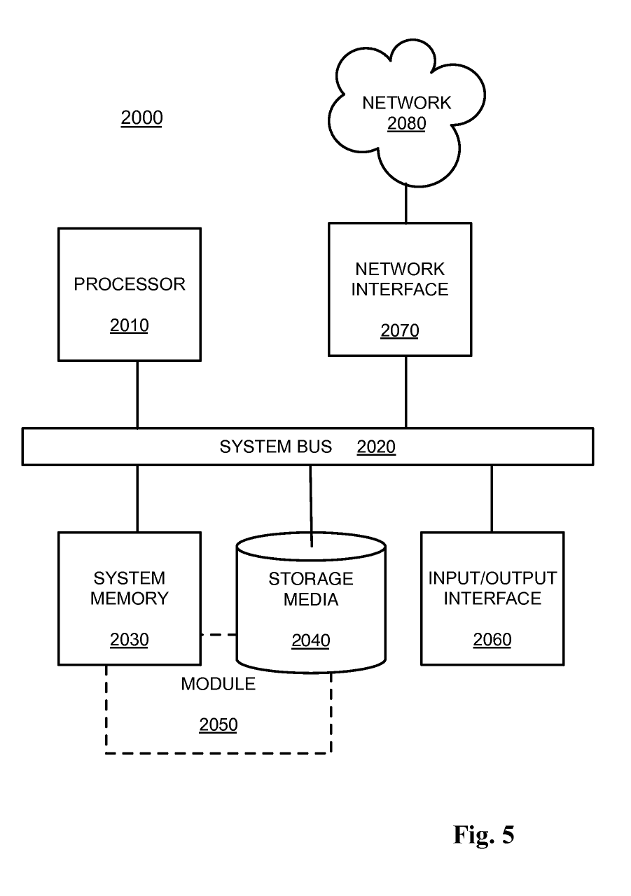

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a Smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method for updating digital wallet accounts to include user financial accounts, comprising:
establishing, by the one or more computing systems, a digital wallet record of a user;
receiving, by one or more computing devices, financial account information for a financial account of the user, the financial account information being received from an issuer computing system associated with an issuer of the financial account of the user in response to an input into the issuer computing system providing an instruction to the issuer computing system to communicate the user's financial account information from the issuer computing system to the one or more computing devices on behalf of the user;
verifying, by the one or more computing devices, an identity of the user; and,
when the identity of the user is verified, establishing, by the one or more computing devices and on behalf of the user, a financial account of the user with the digital wallet record of the user, wherein the financial account is determined based on the financial information received from the issuer computing system on behalf of the user.

2. The method of claim 1, further comprising presenting, by the one or more computing devices, an option for the user to add the user's financial account to the digital wallet record of the user.

3. The method of claim 2, further comprising receiving, by the one or more computing devices, a selection of the option from the user, wherein establishing the financial account of the user with updating the digital wallet record of the user occurs in response to receiving the selection of the option from the user.

4. The method of claim 2, wherein the presenting of the option is performed by communicating information to the issuer computing system to allow the issuer computing system to present the option via the issuer computing system.

5. The method of claim 1, further comprising verifying, by the one or more computing devices, the financial account information received from the issuer computing system, wherein the financial account information is verified before establishing the financial account of the user with the digital wallet record of the user.

6. The method of claim 5, further comprising communicating, by the one or more computing devices, a validation error to the issuer of the financial account in response to an unsuccessful verifying of the financial account information received from the issuer computing system.

7. The method of claim 1, wherein verifying the identity of the user comprises:
receiving, by the one or more computing devices and as part of the financial account information, one or more credentials of the user; and,
confirming, by the one or more computing devices, that the one or more received credentials match one or more corresponding credentials of the user associated with the digital wallet record of the user.

8. A system for updating digital wallet accounts to include user financial accounts, comprising:
a storage device;
a processor communicatively coupled to the storage device, wherein the processor executes application code instructions that are stored in the storage device to cause the system to:
establish a digital wallet record of a user;
receive financial account information for a financial account of the user, the financial account information being received from an issuer computing system associated with an issuer of the financial account of the user in response to an input into the issuer computing system providing an instruction to the issuer computing system to communicate the user's financial account information from the issuer computing system to the one or more computing devices on behalf of the user;
verify an identity of the user; and,
when the identity of the user is verified, establish, on behalf of the user, a financial account of the user with the digital wallet account of the user, wherein the financial account is determined based on the financial information received from the issuer computing system on behalf of the user.

9. The system of claim 8, further comprising presenting an option for the user to add the user's financial account to the digital wallet account of the user.

10. The system of claim 9, further comprising receiving a selection of the option from the user, wherein establishing the financial account of the user with the digital wallet account of the user occurs in response to receiving the selection of the option from the user.

11. The system of claim 9, wherein the presenting of the option is performed by communicating information to the issuer computing system to allow the issuer computing system to present the option via the issuer computing system.

12. The system of claim 8, further comprising verifying the financial account information received from the issuer computing system, wherein the financial account information is verified before updating the digital wallet account of the user.

13. The system of claim 12, further comprising communicating a validation error to the issuer of the financial account in response to an unsuccessful verifying of the financial account information received from the issuer of the financial account.

14. The system of claim 8, further comprising communicating a notification that the digital wallet account of the user has been updated to include the financial account information of the user.

15. A computer program product, comprising:
a non-transitory computer-readable storage device having computer-readable program instructions embodied thereon that when executed by a computer cause the computer to update a digital wallet account to include user financial accounts, the computer-executable program instructions comprising:
computer program instructions to establish a digital wallet record of a user;
computer program instructions to receive financial account information for a financial account of the user, the financial account information being received from an issuer computing system associated with an issuer of the financial account of the user in response to an input into the issuer computing system providing an instruction to the issuer computing system to communicate the user's financial account information from the issuer computing system to the one or more computing devices on behalf of the user;
computer program instructions to verify an identity of the user; and,
when the identity of the user is verified, computer program instructions to establish, on behalf of the user, a financial account of the user with, wherein the financial account is determined based on the financial information received from the issuer computing system on behalf of the user.

16. The computer program product of claim 15, further comprising presenting an option for the user to add the user's financial account to the digital wallet account of the user.

17. The computer program product of claim 16, further comprising receiving a selection of the option from the user, wherein establishing the financial account of the user with the digital wallet account of the user occurs in response to receiving the selection of the option from the user.

18. The computer program product of claim 16, wherein the presenting of the option is performed by communicating information to the issuer computing system to allow the issuer computing system to present the option via the issuer computing system.

19. The computer program product of claim 15, further comprising verifying the financial account information received from the issuer computing system, wherein the financial account information is verified before updating the digital wallet account of the user.

20. The computer program product of claim 19, further comprising communicating a validation error to the issuer of the financial account in response to an unsuccessful verifying of the financial account information received from the issuer computing system.
